(19) United States
(12) Patent Application Publication
(10) Pub. No.: US 2020/0043063 A1
(43) Pub. Date: Feb. 6, 2020

(54) SYSTEM AND METHOD FOR THE NOTIFICATION OF VEHICLE SERVICES

(71) Applicant: GENERAL MOTORS LLC, DETROIT, MI (US)

(72) Inventor: Stephen M. London, West Bloomfield, MI (US)

(21) Appl. No.: 16/055,586

(22) Filed: Aug. 6, 2018

(51) Int. Cl. G06Q 30/02; G06Q 10/02; G06Q 50/30; G07C 5/00; G05D 1/00

(52) U.S. Cl. CPC G06Q 30/0281; G06Q 10/02; G05D 2201/0213; G07C 5/008; G05D 1/0088; G06Q 50/30

(57) ABSTRACT

One general aspect includes a method to provide a notification regarding a service being provided at a vehicle, the method including: (a) receiving, via a controller, a request for access to the vehicle from a third-party service provider; (b) in response to the vehicle access request, via the controller, providing vehicle access to the third-party service provider; (c) operating, via the controller, at least one vehicle sensor to confirm the third-party service provider is providing a service at the vehicle; and (d) generating, via the controller, at least one service notification based at least in part on feedback from the at least one vehicle sensor.

### INTRODUCTION

Vehicle delivery and roadside assistance services come at a convenience to vehicle owners. In the instance of in-vehicle delivery services, vehicle owners do not have to be present to sign for package drop offs and do not have to worry as much about theft since the package is locked inside the vehicle. In the instance of roadside services, vehicle owners do not have to waste time getting gasoline or waiting around while their oil is being changed or some other service is being rendered. However, these conveniences lend themselves to other issues. For instance, it is not always clear to the vehicle owner as to when their service requests have been adequately fulfilled. So, the vehicle owner may be waiting around waiting for their package to be delivered or they may be under the mistaken belief that their vehicle has been refueled when it actually hasn't. Therefore, providing a notification to let the vehicle owner know their requested vehicle services are being carried out and/or have been completed will calm worries and help keep the vehicle owners from wasting their time. Accordingly, it is desirable to provide methods and systems to provide a vehicle owner with a notification when services are conducted at their vehicle. Furthermore, other desirable features and characteristics of the present invention will become apparent from the subsequent detailed description of the invention and the appended claims, taken in conjunction with the accompanying drawings and this background of the invention.

### SUMMARY

Embodiments according to the present disclosure provide a number of advantages. For example, embodiments according to the present disclosure may enable independent validation of autonomous vehicle control commands to aid in diagnosis of software or hardware conditions in the primary control system. Embodiments according to the present disclosure may thus be more robust, increasing customer satisfaction.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method to provide a notification regarding a service being provided at a vehicle, the method including: (a) receiving, via a controller, a request for access to the vehicle from a third-party service provider; (b) in response to the vehicle access request, via the controller, providing vehicle access to the third-party service provider; (c) operating, via the controller, at least one vehicle sensor to confirm the third-party service provider is providing a service at the vehicle; and (d) generating, via the controller, at least one service notification based at least in part on feedback from the at least one vehicle sensor. Other embodiments of this aspect include corresponding computer systems, apparatus, and computer programs recorded on one or more computer storage devices, each configured to perform the actions of the methods.

Implementations may include one or more of the following features. The method further including: (e) receiving, via a controller, a request to terminate vehicle access from the third-party service provider; and step (c) is carried out in response to the vehicle access termination request. The method where vehicle access is provided by unlocking at least one door or a trunk of the vehicle. The method where the at least one vehicle sensor is a fuel sensor configured to indicate when fuel has been delivered to the vehicle. The method where the at least one vehicle sensor is a camera configured to capture an image of the vehicle interior. The method where the at least one vehicle sensor is a GPS chipset/component configured to provide vehicle location data. The method where the at least one service notification is displayed through an infotainment center of the vehicle. The method where the at least one service notification is provided to a mobile computing device to be displayed via a user interface. The method where the vehicle is an autonomous vehicle and step (a) occurs after the vehicle autonomously navigates to a location of the third-party service provider. Implementations of the described techniques may include hardware, a method or process, or computer software on a computer-accessible medium.

One general aspect includes a system to provide a notification regarding a service being provided at a vehicle, the system including: a memory configured to include one or more executable instructions and a controller configured to execute the executable instructions, where the executable instructions enable the controller to: (a) receive a request for access to the vehicle from a third-party service provider; (b) in response to the vehicle access request, provide vehicle access to the third-party service provider; (c) operate at least one vehicle sensor to confirm the third-party service provider is providing a service at the vehicle; and (d) generate at least one service notification based at least in part on feedback from the at least one vehicle sensor. Other embodiments of this aspect include corresponding computer systems, apparatus, and computer programs recorded on one or more computer storage devices, each configured to perform the actions of the methods.

Implementations may include one or more of the following features. The system further including: (e) receive a request to terminate vehicle access from the third-party service provider; and step (c) is carried out in response to the vehicle access termination request. The system where vehicle access is provided by unlocking at least one door or a trunk of the vehicle. The system where the at least one vehicle sensor is a fuel sensor configured to indicate when fuel has been delivered to the vehicle. The system where the at least one vehicle sensor is a camera configured to capture an image of the vehicle interior. The system where the at least one vehicle sensor is a GPS chipset/component configured to provide vehicle location data. The system where the at least one service notification is displayed through an infotainment center of the vehicle. The system where the at least one service notification is provided to a mobile computing device to be displayed via a user interface. The system where the vehicle is an autonomous vehicle and step (a) occurs after the vehicle autonomously navigates to a location of the third-party service provider. Implementations of the described techniques may include hardware, a method or process, or computer software on a computer-accessible medium.

One general aspect includes a non-transitory and machine-readable medium having stored thereon executable instructions adapted to provide a notification regarding a service being provided at a vehicle, which when provided to a controller and executed thereby, causes the controller to: (a) receive a request for access to the vehicle from a third-party service provider; (b) in response to the vehicle access request, provide vehicle access to the third-party service provider; (c) operate at least one vehicle sensor to confirm the third-party service provider is providing a service at the vehicle; and (d) generate at least one service notification based at least in part on feedback from the at least one vehicle sensor. Other embodiments of this aspect include corresponding computer systems, apparatus, and computer programs recorded on one or more computer storage devices, each configured to perform the actions of the methods.

Implementations may include one or more of the following features. The non-transitory and machine-readable memory further including: (e) receive a request to terminate vehicle access from the third-party service provider; and step (c) is carried out in response to the vehicle access termination request. Implementations of the described techniques may include hardware, a method or process, or computer software on a computer-accessible medium.

The above advantage and other advantages and features of the present disclosure will be apparent from the following detailed description of the preferred embodiments when taken in connection with the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 is a block diagram depicting an exemplary embodiment of a communications system capable of utilizing the system and method disclosed herein;

FIG. 2 is a schematic diagram of a communication system including an autonomously controlled vehicle, according to an embodiment;

FIG. 3 is a schematic block diagram of an automated driving system (ADS) for a vehicle, according to an embodiment;

FIG. 4 shows an exemplary flow chart of an exemplary method for the notification of vehicle services, according to an embodiment; and

FIG. 5 shows an exemplary flow chart of an exemplary method for the notification of vehicle services, according to another embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present system and/or method. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The following detailed description is merely exemplary in nature and is not intended to limit the application and uses. Furthermore, there is no intention to be bound by any expressed or implied theory presented in the preceding background and brief summary or the following detailed description. As used herein, the term module refers to an application specific integrated circuit (ASIC), an electronic circuit, a processor (shared, dedicated, or group) and memory that executes one or more software or firmware programs or code segments, a combinational logic circuit, and/or other suitable components that provide the described functionality.

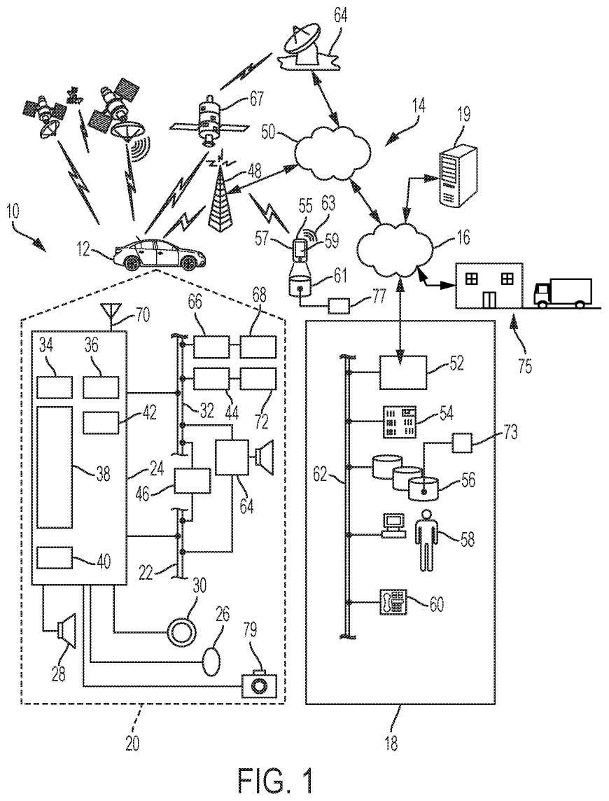

As shown in FIG. 1, there is shown a non-limiting example of a communication system 10 that may be used together with examples of the apparatus/system disclosed herein or to implement examples of the methods disclosed herein. Communication system 10 generally includes a vehicle 12, a wireless carrier system 14, a land network 16 and a data center 18. It should be appreciated that the overall architecture, setup and operation, as well as the individual components of the illustrated system are merely exemplary and that differently configured communication systems may also be utilized to implement the examples of the method disclosed herein. Thus, the following paragraphs, which provide a brief overview of the illustrated communication system 10, are not intended to be limiting.

Vehicle 12 may be any type of manually operated or autonomous vehicle such as a motorcycle, car, truck, bicycle, recreational vehicle (RV), boat, plane, etc., and is equipped with suitable hardware and software that enables it to communicate over communication system 10. In certain embodiments, vehicle 12 may include a power train system with multiple generally known torque-generating devices including, for example, an engine. The engine may be an internal combustion engine that uses one or more cylinders to combust fuel, such as gasoline, in order to propel vehicle 12. The power train system may alternatively include numerous electric motors or traction motors that convert electrical energy into mechanical energy for propulsion of vehicle 12.

Some of the fundamental vehicle hardware 20 is shown generally in FIG. 1 including a telematics unit 24, a microphone 26, a speaker 28, a camera 79, and buttons and/or controls 30 connected to the telematics unit 24. Operatively coupled to the telematics unit 24 is a network connection or vehicle bus 32. Examples of suitable network connections include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is a communication system which provides a variety of services through its communication with the data center 18, and generally includes an electronic processing device 38, one or more types of electronic memory 40, a cellular chipset/component 34, a wireless modem 36, a dual mode antenna 70, and a navigation unit containing a GPS chipset/component 42 capable of communicating location information via a GPS satellite system. GPS component 42 thus receives coordinate signals from a constellation 65 of GPS satellites. From these signals, GPS component 42 can determine vehicle position, which may be used for providing navigation and other position-related services to the vehicle operator. Navigation information can be presented on a display of telematics unit 24 (or other display within the vehicle) or can be presented verbally such as is done when supplying turn-by-turn navigation. The navigation services can be provided using a dedicated in-vehicle navigation module (which can be part of GPS chipset/component 42), or some or all navigation services can be done via telematics unit 24, wherein the location coordinate information is sent to a remote location for purposes of providing the vehicle with navigation maps, map annotations, route calculations, and the like.

The telematics unit 24 may provide various services including: turn-by-turn directions and other navigation-related services provided in conjunction with the GPS component 42; airbag deployment notification and other emergency or roadside assistance-related services provided in connection with various crash and/or collision sensor interface modules 66 and collision sensors 68 located throughout the vehicle; and/or comfort related assistance to adjust the vehicle seat and mirror positions that are provided in connection with various sensor interface modules 66; and/or infotainment-related services where music, internet web pages, movies, television programs, videogames, and/or other content are downloaded by an infotainment center 46 operatively connected to the telematics unit 24 via vehicle bus 32 and audio bus 22. In one example, downloaded content is stored for current or later playback and can be shown on a console display of the infotainment center 46 (i.e., the infotainment head unit (IHU)). The above-listed services are by no means an exhaustive list of all the capabilities of telematics unit 24, but are simply an illustration of some of the services telematics unit 24 may be capable of offering. It is anticipated that telematics unit 24 may include a number of additional components in addition to and/or different components from those listed above.

Vehicle communications may use radio transmissions to establish a voice channel with wireless carrier system 14 so that both voice and data transmissions can be sent and received over the voice channel. Vehicle communications are enabled via the cellular component 34 for voice communications and the wireless modem 36 for data transmission. Any suitable encoding or modulation technique may be used with the present examples, including digital transmission technologies, such as TDMA (time division multiple access), CDMA (code division multiple access), W-CDMA (wideband CDMA), FDMA (frequency division multiple access), OFDMA (orthogonal frequency division multiple access), etc. The cellular component 34 and wireless modem 36 can moreover collaborate to provide wireless health information to ensure their proper functionality for voice communications and data transmissions. To accomplish this effect, dual mode antenna 70 services the GPS component 42 and the cellular component 34.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and data center 18 to communicate with the occupants through audible speech. The vehicle hardware also includes one or more buttons and/or controls 30 for enabling a vehicle occupant to activate or engage one or more of the vehicle hardware components 20. For example, one of the buttons and/or controls 30 can be an electronic pushbutton used to initiate voice communication with data center 18 (whether it be a human such as advisor 58 or an automated call response system). In another example, one of the buttons and/or controls 30 can be used to initiate emergency services. The vehicle hardware also includes one or more vehicle interior cameras 79 (e.g., dash cams) generally designed to capture images of the vehicle interior. For example, the interior cameras 79 can be used to capture an image of the interior (e.g., one or more vehicle seats) to assist in identifying when a package, parcel, or object has been properly delivered to vehicle 12.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, compact disc (CD), MP3, digital video disc (DVD), streamed content, and multimedia functionality independent of the infotainment center 46. Audio component 64 may contain a speaker system, or may utilize speaker 28 via arbitration on vehicle bus 32 and/or audio bus 22.

The vehicle crash and/or collision detection sensor interface 66 is operatively connected to the vehicle bus 32. The collision sensors 68 provide information to telematics unit 24 via the crash and/or collision detection sensor interface 66 regarding the severity of a vehicle collision, such as the angle of impact and the amount of force sustained.

Vehicle sensors 72, connected to various vehicle sensor modules 44 (VSMs) in the form of electronic hardware components located throughout vehicle 12 and use the sensed input to perform diagnostic, monitoring, control, reporting and/or other functions. Each of the VSMs 44 is preferably connected by vehicle bus 32 to the other VSMs, as well as to the telematics unit 24, and can be programmed to run vehicle system and subsystem diagnostic tests. As examples, one VSM 44 can be an engine control module (ECM) that controls various aspects of engine operation such as fuel ignition and ignition timing and another VSM 44 can be a powertrain control module (PCM) that regulates operation of one or more components of the powertrain system. According to one embodiment, the ECM is equipped with on-board diagnostic (OBD) features that provide myriad real-time vehicle health data, such as that received from various sensors including vehicle emissions sensors and vehicle oil sensors as well as provide a standardized series of diagnostic trouble codes (DTCs) which allow a technician to rapidly identify and remedy malfunctions within the vehicle. ECM can also be equipped with fuel tank diagnostics features (via one or more fuel sensors) that provide myriad real-time vehicle fuel data, such as fuel level information. Another VSM 44 can be a body control module (BCM) that governs various electrical components located throughout the vehicle and provide myriad real-time vehicle body data with respect to the vehicle's power door locks, trunk locks, tire pressure, lighting system, engine ignition, vehicle seat adjustment and heating, mirrors, and headlights. Another VSM 44 can be a vehicle immobilization module (VIM) that can prevent the engine from being provided powered and thus immobilize vehicle 12.

A passive entry passive start (PEPS) module, for instance, is another of the numerous of VSMs and provides passive detection of the absence or presence of a passive physical key or a virtual vehicle key. When the passive physical key approaches, the PEPS module can determine if the passive physical key is authentic as belonging to the vehicle 12. The PEPS can likewise use authentication information received from data center 18 to determine if a mobile computing device 57 with virtual vehicle key is authorized/authentic to vehicle 12. If the virtual vehicle key is deemed authentic, the PEPS can send a command to BCM 44 permitting access to the vehicle 12. It should be understood that the PEPS may be an electronic hardware component connected to the vehicle bus 32 or, in an alternative embodiment, may be one or more software code segments uploaded to electronic memory 40.

Wireless carrier system 14 may be a cellular telephone system or any other suitable wireless system that transmits signals between the vehicle hardware 20 and land network 16. According to an example, wireless carrier system 14 includes one or more cell towers 48.

Land network 16 can be a conventional land-based telecommunications network connected to one or more landline telephones, and that connects wireless carrier system 14 to data center 18 and other parties such as one or more third-party service providers 75 and remote computer 19. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

As revealed above, one of the networked devices that can directly or indirectly communicate with the telematics unit 24 is a mobile computing device 57, such as (but not limited to) a smart phone, personal laptop computer or tablet computer having two-way communication capabilities, a wearable computer such as (but not limited to) a smart watch or glasses, or any suitable combinations thereof. The mobile computing device 57 can include computer processing capability, a user interface 59, camera 55, a transceiver capable of communicating with wireless carrier system 14, and/or a GPS module 63 capable of receiving GPS satellite signals and generating GPS coordinates based on those signals. User interface 59 may be embodied as a touch-screen graphical interface capable of user interaction as well as displaying information. Examples of the mobile computing device 57 include the iPhone™ and Apple Watch™ each being manufactured by Apple, Inc. and the Droid™ smart phone manufactured by Motorola, Inc. as well as others.

Mobile device 57 may be used inside or outside of a vehicle, and may be coupled to the vehicle by wire or wirelessly. The mobile device may also be configured to provide services according to a subscription agreement with a third-party facility or wireless/telephone service provider. It should be appreciated that various service providers may utilize the wireless carrier system 14 and that the service provider of telematics unit 24 may not necessarily be the same as the service provider of mobile device 57.

The mobile computing device 57 additionally has a vehicle-related software application 77 (e.g., RemoteLink™ by OnStar, myChevrolet™ by General Motors, etc.) resident on its memory 61. This vehicle app 77 may be downloaded (e.g., from an online application store or marketplace) and stored on the device's electronic memory. When the vehicle app 77 is installed on the mobile computing device 57, in one or more embodiments, the user can be presented with option to turn on a proprietary messaging service (e.g., Apple's Push Notification Services (APNS) service or Firebase Cloud Messaging (FCM) service).

In the examples disclosed herein, the vehicle app 77 enables the mobile computing device user to manage remote vehicle lock/unlock capabilities from mobile computing device 57. In particular, the vehicle app 77 enables the user to sign up for a services account including remote lock/unlock capabilities and to register this services account with vehicle 12. This account information may be stored in the memory 61 and accessible by the vehicle app 77 which may be implementing one or more GUIs via user interface 59. This account information may also be transmitted from the vehicle app 77 to one or more remotely located application program interface (API) suites (discussed below) for storage in the user's account in the database 56.

Data center 18 is designed to provide the vehicle hardware 20 with a number of different system backend functions and, according to the example shown here, generally includes one or more switches 52, servers 54, databases 56, advisors 58, as well as a variety of other telecommunication/computer equipment 60. These various data center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either advisor 58, or an automated response system, and data transmissions are passed on to a modem or other piece of telecommunication/computer equipment 60 for demodulation and further signal processing. The modem or other telecommunication/computer equipment 60 may include an encoder, as previously explained, and can be connected to various devices such as a server 54 and database 56.

Server 54 can incorporate a data controller which essentially controls the operations of server 54. Server 54 may control data information as well as act as a transceiver to send and/or receive the data information (i.e., data transmissions) from one or more of the databases 56, telematics unit 24, and mobile computing device 57. The controller is moreover capable of reading executable instructions stored in a non-transitory machine readable medium and may include one or more from among a processor, microprocessor, central processing unit (CPU), graphics processor, Application Specific Integrated Circuits (ASICs), Field-Programmable Gate Arrays (FPGAs), state machines, and a combination of hardware, software, and firmware components.

Database 56 could be designed to store information in the form of executable instructions such as, but not limited to, numerous API suites. Moreover, in certain instances, these API suites may be accessible to the vehicle owner (i.e., system user), data center 18, or one or more third-party service providers 75. As examples, one API suite can be a vehicle services suite 73 that enables a user to have services provided at vehicle 12 such as, for example, having packages, parcels, or other retail items delivered to the interior cabin of vehicle 12 by service provider 75 or, in another example, having roadside services delivered to the vehicle 12 by service provider 75 (e.g., fuel delivery, oil change, windshield replacement, etc.). Services suite 73 can also communicate with one or more VSMs 44 (e.g., ECM 44) and/or one or more electronic components (GPS chipset/component 42, vehicle interior cameras 79, etc.) via telematics unit 24 to confirm services are being provided at vehicle 12 or confirm services have been provided at vehicle 12. This sensor information can assist services suite 73 to determine whether to send a services notification to the vehicle owner via their mobile computing device 57 to notify the occurrence/completion of the services. This sensor information can otherwise cause services suite 73 to send a services notification to the service provider to indicate services have yet to be properly completed at the vehicle 12.

To enable services to be provided at vehicle 12, service provider 75 may create their own personalized vehicle app 77 to request backend remote vehicle lock/unlock services via vehicle services suite 73, so as to gain temporary access to vehicle 12. Moreover, service provider 75 may perform tasks to create their personalized services account through a vehicle app 77 that can be located on a variety of frontend devices such as, for example, through computer 19 and their own company-owned mobile computing device 57. This services account may be uploaded to services suite 73 or accessible on server 82 (i.e., to support backend functions). Data center 18 may also access one or more additional remote servers and/or remote databases (e.g., Department of Motor Vehicles, social media, etc.) to receive information in support of establishing the vehicle services account. The owner of vehicle 12 may also verify and allow the services account of service provider 75 and corresponding vehicle app 77 access to vehicle 12.

As follows, when the vehicle owner orders items from a retail provider 75 such as, for example, a florist, grocer, or some other retail provider (TARGET™, WALMART™, etc.) and requests retail item delivery to an autonomous embodiment of vehicle 12 (discussed below), the vehicle owner may instruct their vehicle 12 to the location of the retail provider 75 for retail item delivery. The vehicle owner may also notify the retail provider 75 the approximate time and location in which their autonomous vehicle will arrive to receive the retail item. Moreover, when the retail provider 75 determines that vehicle 12 has arrived at their location they can use their vehicle app 77 (corresponding to their services account) to send an access request to data center 18. Services suite 73 is then prompted to send a command to vehicle 12 to unlock one or more of the vehicle doors or the vehicle trunk (i.e., via server 54). In the alternative, upon receiving the access request, services suite 73 may prompt live advisor 86 to unlock at least one of the vehicle doors/vehicle trunk. This unlock command may moreover include time limit parameters such that the vehicle doors/trunk will unlock for a designated time period and relock at the end of such time period to discontinue access into the vehicle cabin. Delivery services suite 73 may also contact the owner of vehicle 12, for example, via their own personal mobile computing device 57 to verify the request is authentic and vehicle access is desired or services suite 73 may send a notification when vehicle entry occurs. In addition, once the retail items are properly delivered to the vehicle, the retail provider 75 may also use their vehicle app 77 to prompt services suite 73 to send a command to vehicle 12 to relock the vehicle doors/trunk. Alternatively, the doors/trunk lid may automatically lock again at the end of the time limit.

In another example, when the vehicle owner orders fuel or other similar vehicle repair services (e.g., oil change, wiper blade change, windshield replacement, etc.) to be delivered to their vehicle 12 from an on-demand roadside assistance provider 75 specializing in various kinds of vehicle repair services (e.g., YOSHI™, FILLD™, URGENT.LY™, SAFELITE™, etc.), the services provider 75 may locate the vehicle 12 via their vehicle app 77 (corresponding to their services account) and travel to the vehicle 12 to deliver the ordered vehicle services. Moreover, when the services provider 75 uses vehicle app 77 to send an access request to data center 18, services suite 73 is prompted to send a command to vehicle 12 to unlock the vehicle's gas cap, gas tank door, trunk, or engine hood (e.g., via a vehicle-installed electronic solenoid directly/indirectly in communication with server 54). In the alternative, upon receiving the access request, services suite 73 may prompt live advisor 86 to unlock the gas cap/gas tank door. This unlock command may moreover include time limit parameters such that the gas cap/gas tank door will unlock for a designated time period and relock at the end of the time period to discontinue access to the gas tank. Delivery services suite 73 may also contact the owner of vehicle 12, for example, via their mobile computing device 57 to verify the request is authentic and vehicle access is desired or services suite 73 may send a notification when vehicle entry occurs. In addition, once fuel delivery has ended, the service provider 75 may also use the vehicle app 77 to prompt services suite 73 to send a command to vehicle 12 to relock the gas cap/gas tank door. Alternatively, the gas cap/gas tank door may automatically lock again at the end of the time limit.

Although the illustrated example has been described as it would be used in conjunction with a manned data center 18, it will be appreciated that the data center 18 can be any central or remote facility, manned or unmanned, mobile or fixed, to or from which it is desirable to exchange voice and data.

### Autonomous Vehicle Aspects

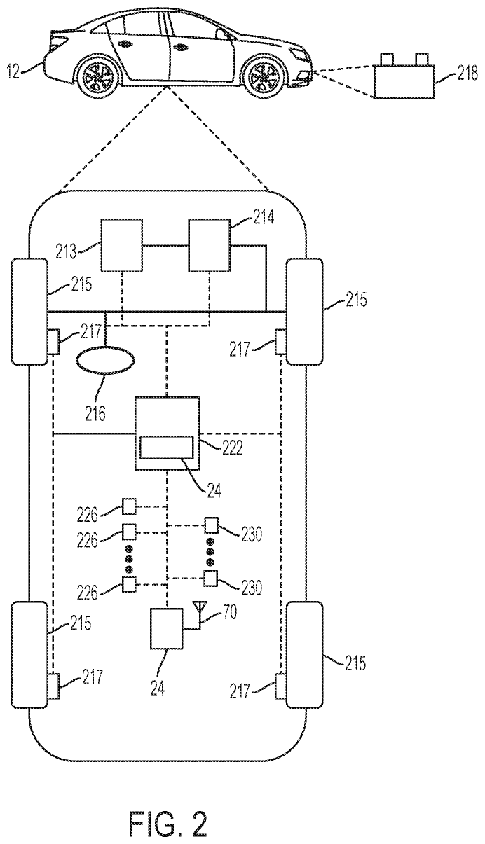

As shown in FIG. 2, communication system 10 may incorporate one or more embodiments of vehicle 12 being autonomous in nature. With such embodiments, in addition to the systems discussed above, vehicle 12 further includes a transmission 214 configured to transmit power from the propulsion system 213 to a plurality of vehicle wheels 215 according to selectable speed ratios. According to various embodiments, the transmission 214 may include a step-ratio automatic transmission, a continuously-variable transmission, or other appropriate transmission. The vehicle 12 additionally includes wheel brakes 217 configured to provide braking torque to the vehicle wheels 215. The wheel brakes 217 may, in various embodiments, include friction brakes, a regenerative braking system such as an electric machine, and/or other appropriate braking systems.

The vehicle 12 additionally includes a steering system 216. While depicted as including a steering wheel for illustrative purposes, in some embodiments contemplated within the scope of the present disclosure, the steering system 216 may not include a steering wheel. The vehicle 12 further includes a battery 218 that supplies electric power to other vehicle systems (e.g., powertrain system). Battery 218 may be connected to vehicle bus 32 to communicate with one or more VSMs 44. For example, OBD 44 may provide the State of Charge (SoC) based on information it receives from one or more battery read sensors. Skilled artisans will understand embodiments of battery 218 are generally known to be incorporated into vehicle embodiments which are not autonomous.

Telematics unit 24 is moreover configured to wirelessly communicate with other vehicles (“V2V”) and/or infrastructure (“V2I”) and/or pedestrians (“V2P”). These communications may collectively be referred to as a vehicle-to-entity communication (“V2X”). In an exemplary embodiment, in addition to the communication channels listed above, this communication system is further configured to communicate via at least one dedicated short-range communications (DSRC) channel. DSRC channels refer to one-way or two-way short-range to medium-range wireless communication channels specifically designed for automotive use and a corresponding set of protocols and standards.

The propulsion system 213, transmission 214, steering system 216, and wheel brakes 217 are in communication with or under the control of at least one controller 222. While depicted as a single unit for illustrative purposes, the controller 222 may additionally include one or more other controllers, collectively referred to as a “controller.” The controller 222 may include a microprocessor such as a central processing unit (CPU) or graphics processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 222 in controlling the vehicle.

Controller 222 includes an automated driving system (ADS) 224 for automatically controlling various actuators in the vehicle. In an exemplary embodiment, ADS 224 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. In an exemplary embodiment, the ADS 224 is configured to communicate automated driving information with and control propulsion system 213, transmission 214, steering system 216, and wheel brakes 217 to control vehicle acceleration, steering, and braking, respectively, without human intervention via a plurality of actuators 230 in response to inputs from a plurality of driving sensors 226, which may include GPS, RADAR, LIDAR, optical cameras, thermal cameras, ultrasonic sensors, and/or additional sensors as appropriate.

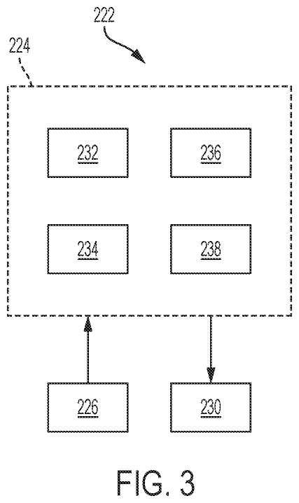

In various embodiments, the instructions of the ADS 224 may be organized by function or system. For example, as shown in FIG. 3, ADS 224 can include a sensor fusion system 232 (computer vision system), a positioning system 234, a guidance system 236, and a vehicle control system 238. As can be appreciated, in various embodiments, the instructions may be organized into any number of systems (e.g., combined, further partitioned, etc.) as the disclosure is not limited to the present examples.

In various embodiments, the sensor fusion system 232 synthesizes and processes sensor data and predicts the presence, location, classification, and/or path of objects and features of the environment of the vehicle 12. In various embodiments, the sensor fusion system 232 can incorporate information from multiple sensors, including but not limited to cameras, LIDARS, radars, and/or any number of other types of sensors. In one or more exemplary embodiments described herein, the sensor fusion system 232 supports or otherwise performs the ground reference determination processes and correlates image data to LIDAR point cloud data, the vehicle reference frame, or some other reference coordinate frame using calibrated conversion parameter values associated with the pairing of the respective camera and reference frame to relate LIDAR points to pixel locations, assign depths to the image data, identify objects in one or more of the image data and the LIDAR data, or otherwise synthesize associated image data and LIDAR data. In other words, the sensor output from the sensor fusion system 232 provided to the vehicle control system 238 (e.g., indicia of detected objects and/or their locations relative to the vehicle 10) reflects or is otherwise influenced by the calibrations and associations between camera images, LIDAR point cloud data, and the like.

The positioning system 234 processes sensor data along with other data to determine a position (e.g., a local position relative to a map, an exact position relative to lane of a road, vehicle heading, velocity, etc.) of the vehicle 12 relative to the environment. The guidance system 236 processes sensor data along with other data to determine a path for the vehicle 12 to follow (i.e., path planning data). The vehicle control system 238 generates control signals for controlling the vehicle 12 according to the determined path.

In various embodiments, the controller 222 implements machine learning techniques to assist the functionality of the controller 222, such as feature detection/classification, obstruction mitigation, route traversal, mapping, sensor integration, ground-truth determination, and the like.

The output of controller 222 is communicated to actuators 230. In an exemplary embodiment, the actuators 230 include a steering control, a shifter control, a throttle control, and a brake control. The steering control may, for example, control a steering system 216 as illustrated in FIG. 2. The shifter control may, for example, control a transmission 214 as illustrated in FIG. 2. The throttle control may, for example, control a propulsion system 213 as illustrated in FIG. 2. The brake control may, for example, control wheel brakes 217 as illustrated in FIG. 2.

### Method

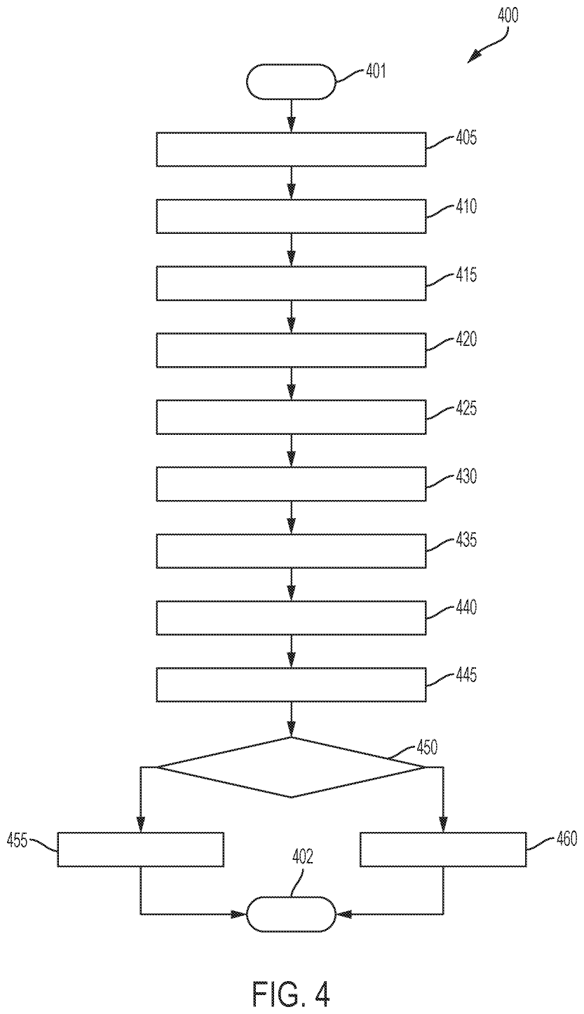

Turning now to FIG. 4, there is shown an embodiment of a method 400 to provide a system user a notification that identifies a vehicle service is being provided or has been provided at their vehicle 12. One or more aspects of notification method 400 may be completed through data center 18 which may include one or more executable instructions incorporated into databases 84 and carried out by server 82. For example, these aspects may be carried out by vehicle services suite 73 in communication with one or more services accounts and corresponding vehicle apps 77. One or more ancillary aspects of method 400 may be completed by mobile computing device 57 and its user interface 59 as well as the console display of the infotainment center 46. One or more ancillary aspects of method 400 may also be completed by one or more vehicle sensors such as, for example a fuel sensor in communication with ECM 44, GPS chipset/component 42, and vehicle interior camera 79. One or more ancillary aspects of method 400 may further be completed by the third-party service provider 75. Skilled artisans will moreover see that telematics unit 24, data center 18, and mobile computing device 57 may be remotely located from each other.

Method 400 is supported by telematics unit 24 being configured to establish one or more communication protocols with data center 18. This configuration may be established by a vehicle manufacturer at or around the time of the telematics unit's assembly or after-market (e.g., via vehicle download using the afore-described communication system 10 or at a time of vehicle service, just to name a couple of examples). In at least one implementation, one or more instructions (e.g., services suite 73) are provided to server 54 and stored on non-transitory computer-readable medium (e.g., database 56). In at least one implementation, one or more instructions are provided to the telematics unit 24 and stored on non-transitory computer-readable medium (e.g., electronic memory 40). Method 400 is supported by mobile computing device 57 being configured to establish one or more communication protocols with data center 18. This configuration may be established by a mobile computing device manufacturer at or around the time of the device's assembly. Method 400 is further yet supported by preconfiguring mobile computing device 57 to exhibit information such as notifications on user interface 57 as well as store one or more corresponding software applications (e.g., vehicle apps 77) in its electronic memory 61. Method 400 is further yet supported by preconfiguring infotainment center 46 to exhibit information such as notifications on the console display.

Method 400 begins at 401 while vehicle 12 is in an OFF state and parked at a location. In step 405, using their personal mobile computing device 57, a user (e.g., the vehicle owner) requests a third-party service provider to provide a vehicle repair service for their vehicle 12. For example, using vehicle app 77, or some other software application uploaded to their mobile computing device 57 (e.g., a software app provided by the third-party service provider), the user can request fuel be delivered to their vehicle from a roadside assistance company 75 (i.e., an on-demand roadside assistance provider) and can provide the specifics of their request (e.g., fuel amount). Step 405 may alternatively consist of the ECM 44 by way of telematics unit 24 requesting the third-party service provider provide a vehicle repair service when it has sensed that the vehicle is low on fuel or that the oil life is low. Step 405 may alternatively consist of an API suite at data center 18 (e.g., a vehicle-share scheduling program) requesting the third-party service provider provide a vehicle repair service at a certain scheduled time and location. In addition, step 405 may also consist of the telematics unit 24 or an API suite at data center 18 requesting the third-party service provider provide a vehicle repair service based on the driving patterns/operator patterns of the vehicle 12. It should also be understood that other systems/devices may request the third-party service provider provide a vehicle repair service and the list above for step 405 should be non-limiting.

In step 410, the roadside assistance company 75 uses their version of vehicle app 77 to determine the location of the vehicle 12 (i.e., via the GPS chipset/component 42) and deploys one of their vehicle refueling vehicles to the designated location of the vehicle 12. Otherwise, the roadside assistance company 75 can somehow request the location of the vehicle 12 be provided from the user (e.g., via the vehicle app 77 or some other app). In step 415, when the deployed refueling vehicle arrives at the vehicle, an employee of the roadside assistance company 75 will request access to the vehicle 12 using the vehicle app 77 on their mobile computing device 57. For instance, this vehicle access request would request the vehicle gas cap/gas tank door be unlocked so that the employee can deliver a specific amount of gasoline to the vehicle 12.

In step 420, the vehicle access request is received at server 54. Server 54 will verify and validate the access request, for example, by verifying the access request is from a vehicle app 77/mobile computing device 57 associated with a valid services account of the roadside assistance company 75. In step 425, upon proper verification and validation and in response to the vehicle access request, server 54 will provide remote vehicle access to the roadside assistance company 75. As follows, server 54 will cause the vehicle gas cap/gas tank door to unlock so the employee of the roadside assistance company 75 can refuel the vehicle 12. In step 430, the roadside assistance company 75 refuels the vehicle 12. In various embodiments, during refueling, server 54 will operate the fuel sensor and/or ECM 44 to monitor and confirm the fuel is being properly delivered to vehicle 12 (i.e., to confirm the third-party service provider is properly providing their service at vehicle 12). In step 435, upon completion of the vehicle refueling, the roadside assistance company 75 will request to terminate their vehicle access. For instance, this vehicle access termination request would request the vehicle gas cap/gas tank door be relocked so that bystanders will not have access to the vehicle's 12 gas tank. In step 440, the access termination request is received at server 54. In step 445, server 54 will remotely end vehicle access for the roadside assistance company 75. In various embodiments, after access termination is accomplished and in response to the termination of the vehicle access, server 54 will operate the fuel sensor and/or ECM 44 to confirm the fuel was properly delivered to vehicle 12.

In step 450, server 54 will determine whether the vehicle sensor information from the fuel sensor indicates that the roadside assistance company 75 properly provided their refueling services at vehicle 12. For instance, the fuel sensor can determine how much of the vehicle tank has been filled and provide a reading feedback to server 54. Moreover, the server 54 can compare this reading feedback to those specifics provided by the user when they requested the third-party services, via vehicle app 77 or some other software application (which is in communication with the services account of the user or roadside assistance company 75). If server 54 determines the roadside assistance company 75 properly provided their refueling services, method 400 will move to step 455; otherwise, method 400 will move to step 460.

In step 455, since server 54 determined the third-party services were adequately provided, server 54 will transmit a service notification embodied as a text message to the user's mobile computing device 57 that can be exhibited via user interface 59. For example, via the vehicle app 77, or some other software application uploaded to mobile computing device 57 (e.g., a software app from the roadside assistance company 75), the text message may state “FUEL HAS BEEN DELIVERED TO YOUR VEHICLE” or the message may state “YOUR VEHICLE HAS RECEIVED 10 GALLONS OF GASOLINE” or, when some other software application uploaded to mobile computing device 57 is being used and may be in communication with vehicle app 77, the message may state “CHEVROLET HAS CONFIRMED THAT 10 GALLONS OF GASOLINE HAS BEEN RECEIVED IN YOUR VEHICLE.” In various embodiments, server 54 will also send this notification to the infotainment center 46 to be exhibited on the console display at the next instance of when the user turns the vehicle 12 to an ON state. The infotainment center 46 notification may also include a supporting audible warning from the audio system 64 such as, for example, chirps or dings (e.g., via an electronic/software chime module within the audio system). The notification may further/alternatively include a supporting haptic feedback announcement from one or more vibratory devices (e.g., a piezo-electric device) installed in the driver seat or one or more passenger seats or steering wheel. After step 455, method 400 moves to completion 402.

In step 460, since server 54 determined the third-party services were adequately provided, server 54 will transmit an alternative service text message notification to the user's mobile computing device 57 (e.g., via vehicle app 77 or another software application) that states: “FUEL WAS NOT PROPERLY RECEIVED AT YOUR VEHICLE, YOU MAY WANT TO CONTACT THE ROADSIDE ASSISTANCE COMPANY FOR MORE INFORMATION.” In addition, or in the alternative, server 54 will send a text message notification to the mobile computing device 57 of the roadside assistance company 75 and/or its employee that states: “IT APPEARS YOUR SERVICES FOR THIS VEHICLE ARE INCOMPLETE, PLEASE CONTACT THE VEHICLE'S OWNER IF THERE IS AN ISSUE.” After step 460, method 400 moves to completion 402.

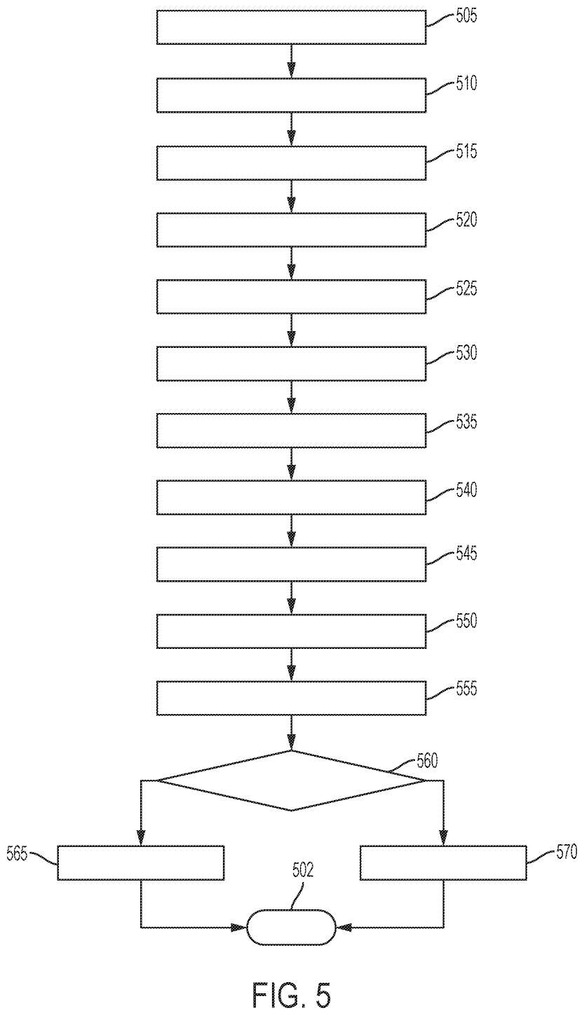

Turning now to FIG. 5, there is shown an alternative embodiment of a method 500 to provide a system user (e.g., a vehicle owner) with a notification that identifies a vehicle service is being provided or has been provided at their vehicle 12. One or more aspects of notification method 500 may be completed through data center 18 which may include one or more executable instructions incorporated into databases 84 and carried out by server 82. For example, these aspects may be carried out by vehicle services suite 73 in communication with one or more services accounts and corresponding vehicle apps 77. One or more aspects of notification method 500 may be completed through an autonomous vehicle 12. One or more ancillary aspects of method 500 may be completed by mobile computing device 57 and its user interface 59 as well as the console display of the infotainment center 46. One or more ancillary aspects of method 500 may also be completed by one or more vehicle sensors such as, for example, GPS chipset/component 42 and vehicle interior camera 79. One or more ancillary aspects of method 500 may further be completed by the third-party service provider 75. Skilled artisans will moreover see that telematics unit 24, data center 18, and mobile computing device 57 may be remotely located from each other.

Method 500 begins at 101 while vehicle 12 is an autonomous vehicle and parked at a known location or, when the vehicle is in a rideshare environment, the vehicle 12 is completing one or more non-related rideshare tasks (i.e., picking up and dropping off other vehicle passengers). In step 505, using their mobile computing device 57, a user (e.g., the vehicle owner) orders retail items from a third-party service provider and requests these items be delivered into the cabin of their vehicle 12. For example, using vehicle app 77 or some other software application uploaded to their mobile computing device 57 (e.g., a software app provided by the third-party service provider), the user can purchase retail items from a retail provider 75 and request that the retail provider package and deliver the retail items into the vehicle upon arrival at the retail provider's 75 location. In step 510, using vehicle app 77 on their mobile computing device 57, the user will command vehicle 12 to autonomously navigate to the location of the retail provider 75. Otherwise, this command may be transmitted directly from mobile computing device 57 to vehicle 12 (via telematics unit 24) or the command may be transmitted to server 54 to be relayed to vehicle 12.

In step 515, upon receiving the command, vehicle 12 will navigate itself from the parking location to the retail provider's 75 location. Upon arrival of the vehicle 12 and after the retail items have been properly packaged, in step 520, the retail provider will request access to the vehicle 12 using the vehicle app 77 on their mobile computing device 57. For instance, this vehicle access request would request the vehicle doors/trunk lid of vehicle 12 be unlocked so that an employee of the retail provider 75 can deliver/drop off the purchased retail items into the cabin of vehicle 12.

In step 525, the vehicle access request is received at server 54. Server 54 will verify and validate this access request, for example, by verifying the access request is from a vehicle app 77/mobile computing device 57 associated with a valid services account of the retail company 75. In step 530, upon proper verification and validation and in response to the vehicle access request, server 54 will provide remote vehicle access to the retail company 75. As follows, server 54 will cause the vehicle doors/trunk lid to unlock so the employee of the retail company 75 can drop the retail items off in the vehicle. It should be understood that the access request may be in relation to unlocking the trunk of the vehicle so that the employee may deliver the goods into the vehicle's trunk instead. In step 535, the retail items are dropped off in the vehicle.

In step 540, after the goods are dropped off into the vehicle, the retail company 75 will request to terminate their vehicle access. For instance, this vehicle access termination request would cause the vehicle doors/trunk lid to be relocked so that bystanders will not have access to the vehicle's 12 cabin and cannot steal or otherwise remove the retail items. In step 545, the access termination request is received at server 54. In step 550, server 54 will remotely end vehicle access for the retail company 75. In step 555, in response to the termination of the vehicle access, which may be after the doors are locked (or trunk lid is locked), server 54 will operate various vehicle sensors to confirm the retail items were properly delivered. For example, server 54 may retrieve vehicle location information via the GPS chipset/component 42 to confirm the vehicle's location. Additionally, the server may operate the vehicle interior camera 79 to capture an image in the vehicle interior, for example, to capture an image of the vehicle's front and/or backseats (e.g., in the second or third row).

In step 560, server 54 will determine whether the vehicle sensor information from these vehicle sensors indicates that the retail company 75 properly provided their delivery services at vehicle 12. For example, implementing one or more commonly known and used object detection, recognition and tracking techniques (TENSORFLOW by GOOGLE™), server 54 may analyze the captured image to determine whether packaged items are found resting on one or more vehicle interior seats. Moreover, implementing a known online web mapping service (e.g., GOOGLE MAPS™), server 54 may analyze the received vehicle location in comparison to the location of the retail company 75 having been registered with the provider of the web mapping service, to confirm the vehicle is at the proper location for package delivery to occur. If server 54 determines the retail company 75 properly provided their retail delivery services, method 500 will move to step 565; otherwise, method 500 will move to step 570.

In step 565, since server 54 determined the third-party services were adequately provided, server 54 will transmit a service notification embodied as a text message to the mobile computing device 57 of the user that can be exhibited via user interface 59. For example, via the vehicle app 77, or some other software application uploaded to mobile computing device 57 (e.g., a software app from the retail company 75), the text message may state “YOUR RETAIL ITEMS HAVE BEEN DELIVERED TO YOUR VEHICLE.” In various embodiments, for example, when vehicle 12 is deployed in an autonomous rideshare system, server 54 will also send this notification to the infotainment center 46 to be exhibited on the console display at the next instance of when the user gets into the vehicle (e.g., when telematics unit 24 pairs with the user's mobile computing device 57 or when PEPS module recognizes the user's mobile computing device 57). Moreover, this infotainment notification may be tailored to the user and may state “HI STEVE, YOUR ITEMS ARE SITTING IN THE BACKSEAT.” The infotainment center 46 notification may also include a supporting audible warning from the audio system 64 such as, for example, chirps or dings (e.g., via an electronic/software chime module within the audio system). The notification may further/alternatively include a supporting haptic feedback announcement from one or more vibratory devices (e.g., a piezo-electric device) installed in the driver seat or one or more passenger seats or steering wheel. After step 565, method 500 moves to completion 502.

In step 470, since server 54 determined the third-party services were adequately provided, server 54 will transmit an alternative service text message notification to the mobile computing device 57 of the user (e.g., via vehicle app 77 or another software application) that states: “IT APPEARS YOUR ITEMS WERE NOT PROPERLY DELIVERED TO YOUR VEHICLE, YOU MAY WANT TO CONTACT THE RETAIL COMPANY FOR MORE INFORMATION.” In addition, or in the alternative, server 54 will send a text message notification to the mobile computing device 57 or computer 19 of the retail assistance company 75 that states: “IT APPEARS YOUR DELIVERY SERVICES ARE INCOMPLETE FOR THE VEHICLE, PLEASE CONTACT THE VEHICLE'S OWNER IF THERE IS AN ISSUE.” In addition, server 54 may also transmit a remote shut down to telematics unit 24 of vehicle 12 to cause the vehicle turn to an OFF state and prevent vehicle departure (via the VIM), at least until the delivery services are properly carried out or the user overrides this command. After step 570, method 500 moves to completion 502.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the system and/or method that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for” in the claim.

1. A method to provide a notification regarding a service being provided at a vehicle, the method comprising:
(a) receiving, via a controller server at a data center remotely located from the vehicle, a request for access to the vehicle from a third-party service provider, wherein the request is generated and transmitted via a computing device remotely located from the vehicle;
(b) in response to the vehicle access request, via the controller server, providing vehicle access to the third-party service provider;
(c) operating, via the controller server, at least one vehicle sensor to confirm the third-party service provider is providing a service at the vehicle or has provided a service at the vehicle; and
(d) generating, via the controller server, at least one service notification based at least in part on feedback from the at least one vehicle sensor, wherein the service notification is configured to be transmitted to a vehicle owner so as to inform the vehicle owner whether the third-party service provider did or did not adequately provide the service at the vehicle.

2. The method of claim 1, further comprising:
(e) receiving, via a controller the server, a request to terminate vehicle access from the third-party service provider; and
step (c) is carried out in response to the vehicle access termination request.

3. The method of claim 1, wherein the third-party service provider is a retail provider, and wherein vehicle access is provided by unlocking at least one door or a trunk of the vehicle to allow the third-party service provider to deliver one or more retail items in a cabin of the vehicle.

4. The method of claim 1, wherein the third-party service provider is a roadside assistance provider, and wherein the at least one vehicle sensor is a fuel sensor configured to indicate when fuel has been delivered to the vehicle by the third-party service provider.

5. The method of claim 1, wherein the at least one vehicle sensor is a camera configured to capture an image of the vehicle interior, wherein the server will implement one or more object detection techniques on the captured image to determine whether a retail item is located in the vehicle interior.

6. The method of claim 1, wherein the at least one vehicle sensor is a GPS chipset/component configured to provide vehicle location data to confirm that the vehicle is at the location of the third-party service provider.

7. The method of claim 1, wherein the at least one service notification is displayed through an infotainment center of the vehicle.

8. The method of claim 1, wherein the at least one service notification is provided to a mobile computing device to be displayed via a user interface.

9. The method of claim 1, wherein the vehicle is an autonomous vehicle and step (a) occurs after the vehicle autonomously navigates to a location of the third-party service provider.

10. A system to provide a notification regarding a service being provided at a vehicle, the system comprising:
a memory configured to comprise one or more executable instructions and a controller configured to execute the executable instructions, wherein the memory and controller are part of a server at a data center remotely located from the vehicle, and wherein the executable instructions enable the controller to:
(a) receive a request for access to the vehicle from a third-party service provider, wherein the request is generated and transmitted via a computing device remotely located from the vehicle;
(b) in response to the vehicle access request, provide vehicle access to the third-party service provider;
(c) operate at least one vehicle sensor to confirm the third-party service provider is providing a service at the vehicle or has provided a service at the vehicle; and
(d) generate at least one service notification based at least in part on feedback from the at least one vehicle sensor, wherein the service notification is configured to be transmitted to a vehicle owner so as to inform the vehicle owner whether the third-party service provider did or did not adequately provide the service at the vehicle.

11. The system of claim 10, further comprising:
(e) receive a request to terminate vehicle access from the third-party service provider; and
step (c) is carried out in response to the vehicle access termination request.

12. The system of claim 10, wherein the third-party service provider is a retail provider, and wherein vehicle access is provided by unlocking at least one door or a trunk of the vehicle to allow the third-party service provider to deliver one or more retail items in a cabin of the vehicle.

13. The system of claim 10, wherein the third-party service provider is a roadside assistance provider, and wherein the at least one vehicle sensor is a fuel sensor configured to indicate when fuel has been delivered to the vehicle by the third-party service provider.

14. The system of claim 10, wherein the at least one vehicle sensor is a camera configured to capture an image of the vehicle interior, wherein the server will implement one or more object detection techniques on the captured image to determine whether a retail item is located in the vehicle interior.

15. The system of claim 10, wherein the at least one vehicle sensor is a GPS chipset/component configured to provide vehicle location data to confirm that the vehicle is at the location of the third-party service provider.

16. The system of claim 10, wherein the at least one service notification is displayed through an infotainment center of the vehicle.

17. The system of claim 10, wherein the at least one service notification is provided to a mobile computing device to be displayed via a user interface.

18. The system of claim 10, wherein the vehicle is an autonomous vehicle and step (a) occurs after the vehicle autonomously navigates to a location of the third-party service provider.

19. A non-transitory and machine-readable medium having stored thereon executable instructions adapted to provide a notification regarding a service being provided at a vehicle, which when provided to a controller and executed thereby, causes the controller to:
(a) receive a request for access to the vehicle from a third-party service provider, wherein the request is generated and transmitted via a computing device remotely located from the vehicle;
(b) in response to the vehicle access request, provide vehicle access to the third-party service provider;
(c) operate at least one vehicle sensor to confirm the third-party service provider is providing a service at the vehicle or has provided a service at the vehicle;
(d) generate at least one service notification based at least in part on feedback from the at least one vehicle sensor, wherein the service notification is configured to be transmitted to a vehicle owner so as to inform the vehicle owner whether the third-party service provider did or did not adequately provide the service at the vehicle; and
wherein the non-transitory and machine-readable medium and controller are part of a server at a data center remotely located from the vehicle.

20. The non-transitory and machine-readable memory of claim 19, further comprising:
(e) receive a request to terminate vehicle access from the third-party service provider; and
step (c) is carried out in response to the vehicle access termination request.
